(19) United States
(12) Patent Application Publication
(10) Pub. No.: US 2009/0076186 A1
(43) Pub. Date: Mar. 19, 2009

(54) Adhesive composition and element for attaching to human skin

(75) Inventor: Paul Lassalle, Biarritz (FR)

Correspondence Address: YOUNG & THOMPSON, 209 Madison Street, Suite 500, ALEXANDRIA, VA, 22314, US

(73) Assignee: B. Braun Medical Sas, Boulogne-Billancourt (FR)

(21) Appl. No.: 11/918,573

(22) PCT Filed: Apr. 19, 2006
(86) PCT No.: PCT/FR2006/000860

§ 371 Date: Oct. 16, 2007

(30) Foreign Application Priority Data
Apr. 19, 2005 (FR) 0503903

(51) Int. Cl. C08L 23/06

(52) U.S. Cl. 523/111

(57) ABSTRACT

An adhesive composition containing 55 to 75% of a continuous phase and 25 to 45% of a discontinuous phase constituted of hydrophilic polymers in the form of hydrocolloids, the continuous phase containing 5 to 10% of a textured copolymer constituted of a styrene-isoprene-styrene or styrene-butadiene-styrene sequence copolymer having a majority of at least triple sequences, more than 22% of a tackifying agent, and 10 to 30% of a plasticizer, these percentages being indicated with regard to the whole of the composition. The tackifying agent is a mixture of tackifying agents that contain a majority of high-activity tackifying agents based on terpene resins, and a significant quantity of a tackifying agent with a low activity of adhesiveness but having reinforcing properties. At least half of the tackifying agent is constituted of a high-activity tackifying agent based on terpene resin such as a terpene-styrene polyterpene resin.

The invention relates to an adhesive composition intended basically to form an adhesive element, for example for pouches for collecting body fluids such as ostomy pouches or similar elements such as dressings.

The following terminology will be used in the present specification.

An “adhesive composition”, in particular for a pouch for collecting body fluids, comprises a “continuous phase” based on polymers, elastomers, etc. and a “discontinuous phase” basically containing hydrocolloids.

The continuous phase contains various copolymers, polymers, elastomers which serve to create a texture, optionally plasticisers which serve to increase the flexibility of the composition, and tackifying resins sometimes referred to using the neologism “tackifier”.

This terminology, which distinguishes the texture ingredients (elastomers, polymers, copolymers) from the plasticisers and tackifying agents, should not be regarded as absolute. Indeed, most polymers, copolymers and elastomers have to a greater or lesser extent properties of texture (unless they are liquid), of plasticiser and of tackifying agent in the presence of other ingredients. The effect of these ingredients must therefore be considered within the context of the adhesive compositions used for the direct or indirect attachment of pouches for collecting body fluids. Nevertheless, this terminology allows the various adhesive compositions used for the attachment of pouches for collecting body fluids to be defined.

The adhesive compositions for pouches for collecting body fluids are used for the attachment of a pouch by direct adhesion to the skin of a human being, around an orifice for discharging excrement. The adhesion can be provided to last a relatively short time, which may be less than one day, or a relatively long time, which may be about one week. The adhesive compositions used for these various applications therefore have differing properties depending on whether they have to remain attached for a shorter or longer time. Nevertheless, they all have a certain number of common properties.

Adhesive compositions for attaching pouches for collecting body fluids must first have specific mechanical properties. These properties are basically first the mechanical strength of a pouch, which may be of a specific weight, without the adhesive composition becoming detached from the skin, then the non-leakage of the adhesive composition and finally good adaptability in order to provide a high degree of convenience and comfort, in terms not only of ease of fitting and removal but above all of sufficient flexibility, so the patient is as far as possible unaware of the presence of the adhesive composition and the pouch.

Adhesive compositions for attaching pouches for collecting body fluids then have to have specific chemical properties. It is crucial that the adhesive composition does not cause irritation of the skin.

The first adhesive compositions, which were used widely in the 1960s, were based on polybutene (continuous phase) and hydrocolloids. The amounts of the two ingredients were very similar. The problems presented by these adhesive compositions were basically the fact that polybutenes are not good texture polymers and can easily display phenomena of dissolution and disintegration leading to the formation of leaks.

An example of a composition having small amounts of polybutenes with a styrene block copolymer is described in document U.S. Pat. No. 5,492,943 but also presents the aforementioned problem of dissolution and disintegration.

There has also been proposed, as French patent FR-2 392 076 states, an adhesive composition in the form of a gel containing at least one physically crosslinked elastomer forming the continuous phase in which hydrocolloids are dispersed. In particular, specific compositions contain approximately 10% by weight of styrene-isoprene-styrene or styrene-butadiene-styrene block copolymers basically based on triple blocks, from 16.7 to 20.6% of tackifying agents known as “tackifying resins”, from 18 to 25% of a liquid ingredient acting as a plasticiser and from 45.5 to 52% of hydrocolloids. These compositions were used at a thickness of about 3 mm, so they have the necessary properties not only of adhesiveness but also of convenience of fitting and removal. Although the pouch attachment means produced with this adhesive composition had much better properties in terms of resistance to disintegration than the known previous compositions, they were relatively rigid and provided only a low degree of comfort.

Similarly, attempts have been made to use these polymers, mixed in significant proportion with a large amount of inorganic filler, more specifically particles of clay, as described in document US2003/0225356. However, the attachment means produced with this adhesive composition also provided only a low degree of comfort.

It was therefore generally concluded that the use of styrene-isoprene-styrene-type copolymers, such as “Kraton”, as the sole texture polymer presented problems in terms of rigidity: the compositions prepared are suitable only to be worn for a very long period of time, necessitating exceptional texture properties. Thus, the document “Skin Barriers for Stoma Care” by Dr Kenji Tazawa, 2001, Alcare Co., Ltd. (Tokyo), mentions the poor results obtained with texture copolymers of this type.

This is the reason why these styrene-isoprene-styrene copolymers have been used either with block copolymers of the same type but having a large amount of double blocks, with two sequences only, or with polyisobutenes which present the aforementioned problem of dissolution and disintegration, or in association with a layer of foam.

Thus, international patent application WO 99/54422 describes a pressure-sensitive adhesive composition similar to that of the aforementioned French patent FR-2 392 076, but in which the texture polymer is a block copolymer basically based on double blocks and having lower rigidity than that of the triple block copolymer. The amount of block copolymer, in all the compositions mentioned, is very high and varies between 18 and 40%. This composition forms elements made with thicknesses of about 1 mm to be used for attaching pouches for receiving body fluids.

European patent EP-1 007 597 also relates to adhesive materials comprising a continuous phase and a discontinuous phase of hydrophilic polymers. The continuous phase consists of a mixture of liquid rubber and solid rubber, the liquid rubber being preponderant. The range of the amount of the discontinuous phase is extremely broad (from 10 to 70%). This document states that the advantage of this adhesive composition is to avoid the use of the tackifying resins that is believed to be the cause of skin irritation. However, an example mentions the presence of a small amount (still less than 12%) of a tackifying resin with moderate to low activity (“Regalite R91”). The absence of “resinous materials” is recommended.

The invention relates to an adhesive composition which, in contrast to the teachings of the last-cited document, contains a very large amount of tackifying agent introduced instead of the hydrocolloids.

More specifically, for a concentration of styrene-isoprene-styrene-type block copolymer or the like similar to that of specific known compositions (less than 10%), the adhesive composition according to the invention contains a small amount of hydrocolloids (25 to 45%) and an increased amount of tackifying agents (more than 22%), in particular of tackifying agents having particularly marked properties of adhesiveness.

More specifically, the tackifying agent used comprises a mixture of tackifying agents containing a majority of high-activity tackifying agents based on terpene resins, a small optional amount of a moderate-activity tackifying agent and a significant amount of a tackifying agent with low activity of adhesiveness but also having reinforcing properties.

The classification of the activity of the tackifying agents as being “low”, “moderate” or “high” is defined by an empirical test commonly used in the technical field in question. In this test, a reference composition is prepared with a given amount of a defined copolymer and a given amount of the resin, the properties of adhesiveness of which have to be determined, equal to the amount of the copolymer. A standardised strip tearing test is then carried out in a tensile test machine and allows the properties of adhesiveness to be classified in accordance with the force required to tear the strip, under given conditions of time of contact with the composition before tearing and of tearing speed. According to this test, low activity corresponds to a tearing force of less than 6 N, moderate activity corresponds to a force of from 6 to 14 N and high activity to a force of from 14 to 25 N. In the subsequent examples, use is made, for example, of tackifying agents providing respective forces of 4, 12 and 19 N. Under the conditions stated, the tackifying agent cited in the aforementioned European patent EP-1 007 597 provides a tearing force close to 6 N.

With the definitions provided hereinbefore, an adhesive composition according to the invention contains from 55 to 75% of a continuous phase and from 25 to 45% of a discontinuous phase consisting of hydrophilic polymers in the form of hydrocolloids, the continuous phase containing from 5 to 10% of a texture copolymer consisting of a styrene-isoprene-styrene or styrene-butadiene-styrene-type block copolymer having a majority of at least triple blocks, more than 22% of tackifying agent and from 10 to 30% of a plasticiser, these percentages being given relative to the composition as a whole.

Preferably, the continuous phase contains from 6 to 10% of a texture copolymer consisting of a styrene-isoprene-styrene or styrene-butadiene-styrene-type block copolymer having a majority of at least triple blocks, from 23 to 38% of tackifying agent and from 13 to 25% of a plasticiser, these percentages being given relative to the composition as a whole.

The styrene-isoprene-styrene or styrene-butadiene-styrene-type continuous-phase texture copolymer having a majority of at least triple blocks preferably consists of a styrene-isoprene-styrene block copolymer composed entirely or for the most part of at least triple blocks, the double blocks forming merely a minority of the copolymer.

Examples of texture copolymers which are suitable in accordance with the invention include, for example, specific “Kraton” copolymers from Shell Chemical Company, for example of the D11 type (D1161, D1117 and D1112, these last two containing 67 and 62% respectively of at least triple blocks).

At least half of the tackifying agent consists of a high-activity tackifying agent based on polyterpene resin.

The high-activity tackifying agent is advantageously a terpene-styrene polyterpene resin having advantageously a softening point of approximately 105° C. (ball and ring method) and a molecular weight by mass of about 1,000.

One tackifying agent has low activity and consists of a reinforcing resin. Preferably, it forms at most one third of the tackifying agent. A tackifying agent of this type is advantageously a thermoplastic polymer derived basically from α-methylstyrene having, for example, a molecular weight by mass of between 300 and 3,000, such as the polymer “Kristalex” F100 from Hercules. A reinforcing resin of this type allows the resilience of the triple block copolymer to be varied and prevents the plasticisers from migrating even if they are present in a large amount.

A small amount of the tackifying agent can consist of a low to moderate-activity tackifying agent such as “Regalite” from Hercules, which is a completely hydrogenated resin.

The discontinuous phase consisting of hydrophilic polymers in the form of hydrocolloids in an amount of from 25 to 45% can be of a type well known in the art, containing a large amount of compounds such as cellulose fibres, sodium, crosslinked or other carboxymethylcellulose, and hydroxyethylcellulose and also compounds similar to guar gum, and substances such as xanthans, alginates, pectin, gelatin, psyllium, carob extract, gum arabic, agarose, carrageenans and polyacrylamides.

Cellulose fibres have, in particular, an advantageous role owing to the creation of a mechanical network formed by the entanglement of the fibres. This entanglement increases, in particular, the cohesion of the mixture and thus limits variations in size during shrinkage under the conditions of use while at the same time promoting the spread of moisture into the adhesive mass by capillary action.

It is furthermore advantageous that the adhesive composition also comprises an agent having a medical effect selected, for example, from chitosan and α-L-fucose.

The invention also relates to an element for attaching a pouch for collecting body fluids comprising the aforementioned adhesive composition and, on the face remote from that which must be in contact with the skin, a coating film having a property for transferring water in one direction, i.e. a film which allows the water absorbed by the adhesive composition, more specifically hydrocolloids contained therein, to evaporate by passing outward through the microperforations and thus to be released.

A film of this type is a polyethylene film having standardised microperforations allowing water to evaporate in one direction but preventing water from passing in the other direction.

It was found that the weld produced between, on the one hand, an element of this type for attaching a pouch for collecting body fluids formed from the adhesive composition provided with the polyethylene film and, on the other hand, the pouch, around the hole formed in the adhesive element, remains highly flexible and therefore improves patient comfort.

### COMPOSITION EXAMPLES

There was first prepared a composition (Example 4) consisting of a “Kraton” D1161BS styrene-isoprene-styrene-type copolymer (11.76 kg), a “Regalite” R 1100 tackifying resin (8.16 kg), a terpene-styrene polyterpene resin having a molecular weight of about 1,000 (17.64 kg), a “Kristalex” F100 tackifying resin (11.76 kg) also having a reinforcing effect, and a “Durasyn” 164 plasticiser (24.72 kg). There were added 6 kg of “BER400” cellulose fibres, then 35.16 kg of “Cekol” and 4.8 kg of guar gum HV225.

After each introduction, mixing for at least 10 min was required to achieve good homogeneity. The final mixing lasted 50 min and the extrusion time was approximately 60 min.

The composition thus obtained was extruded in the form of a sheet having a thickness of 1 mm and cut up into elements used for testing the attachment of pouches for receiving body fluids.

Further compositions were prepared in accordance with the following table.

| | 1 | 2 | 3 | 4 | 5 | 6 | 7 | 8 |
|---|---|---|---|---|---|---|---|---|
| Texture | | | | | | | | |
| “Kraton” D11 | 9.7 | | | 9.8 | | | | 9.2 |
| “Vector 4113” | | 9.7 | | | | 8.6 | 9.3 | |
| “Cariflex S-1707” | | | 9.8 | | 8.6 | | | |
| Resins | | | | | | | | |
| High activity | | | | | | | | |
| “Dercolyte” | | | | 14.7 | | | 16.2 | |
| “Piccolyte S” | 23.5 | 21.5 | | | | 15.7 | | 18.8 |
| “Zonatac” | | | 15.7 | | 15.7 | | | |
| Low activity | | | | | | | | |
| “Regalite” R11 | 6.1 | | | 6.8 | 6.9 | | 10.0 | |
| “Arkon P” | | 6.1 | 7.8 | | | 7.9 | | 5.5 |
| Reinforcing effect | | | | | | | | |
| “Kristalex KF” | 9.7 | | | 9.8 | | | | |
| “Piccotex” | | | 9.8 | | | 8.6 | 9.3 | |
| “LX-685” | | 9.7 | | | 8.6 | | | 9.2 |
| Total, resins | 39.3 | 37.3 | 33.3 | 31.3 | 31.2 | 32.2 | 35.5 | 33.5 |
| Plasticiser | 21.4 | 23.4 | 20.6 | 20.6 | 18.2 | 19.7 | 17.8 | 24.8 |
| “Durasyn” | | | | | | | | |
| Hydrocolloids | | | | | | | | |
| CMC “Cekol” | 15.9 | 15.9 | 21.3 | 29.3 | 29.5 | 25.0 | 19.3 | |
| Karaya gum | | | | | | | 5.0 | |
| “BER400” fibres | 4.0 | 4.0 | 3.0 | 5.0 | 4.0 | 3.0 | 4.5 | 4.5 |
| CMC “7MXF” | 4.7 | 4.7 | | | | 6.5 | | 12.0 |
| Guar gum | 5.0 | | | 4.0 | | | | 7.0 |
| “Superabsorbent” A500 | | 5.0 | 12.0 | | 8.5 | 5.0 | 8.6 | 8.0 |
| Chitosan | | | | | | | | 1.0 |
| Total, hydrocolloids | 29.6 | 29.6 | 36.3 | 38.3 | 42.0 | 39.5 | 37.4 | 32.5 |
| Adhesiveness | 5.0 | 4.8 | 4.2 | 4.0 | 4.7 | 4.6 | 4.7 | 4.2 |
| Modulus of elasticity | 0.17 | 0.18 | 0.175 | 0.175 | 0.18 | 0.17 | 0.19 | 0.175 |
| Maximum force | 1.3 | 1.2 | 1.2 | 1.3 | 1.3 | 1.3 | 1.5 | 1.3 |
| Absorption | 100 | 150 | 225 | 185 | 350 | 220 | 190 | 70 |

The term “resins” designates, as is generally acknowledged in the scientific community and in the present specification, compounds, the molecular weight by number of which is less than 5,000, compounds of greater molecular weight being called “polymers” or “copolymers”.

The adhesiveness is determined as stated hereinbefore.

The modulus of elasticity and the maximum tearing force are defined by the standardised methods of mechanical tests.

It will also be noted that the lowest adhesiveness corresponds to the greatest percentage of texture copolymer, this result confirming the analysis provided at the start of the present specification with reference to the aforementioned document “Skin Barriers for Stoma Care” by Dr Kenji Tazawa.

The texture copolymer may be, instead of various types of “Kraton”, a copolymer such as “Vector 4113” from Dexco or “Cariflex S-1707” from Shell.

The high-activity resin may be, instead of “Dercolyte”, “Piccolyte” S or HM from Hercules or “Zonatac” from Arizona/Bergvik.

The reinforcing resin may be, instead of “Kritalex”, a “Piccotex” resin from Hercules or “LX-685” from Neville.

The low-activity resin may be, instead of “Regalite”, the resin “Arkon P” from Arakawa.

The plasticiser may be, instead of “Durasyn”, a paraffin, a castor oil, a synthesis paraffin wax from Shell, the resin “Sun 5512” from Sun or “Primol” from Hercules.

The hydrocolloids may contain various substances such as xanthans, alginates, pectin, gelatin, psyllium, carob extract, gum arabic, agarose, carrageenans, polyacrylamides and the like.

The agent having a medical effect may be, instead of chitosan, vitamin E, aloe vera, collagen, allantoin, an arnica extract, vitamin B5, an echinacea or the like.

Finally, it is sometimes advantageous to incorporate an antioxidant such as “Irganox” 1010 from Ciba.

Further properties of the compositions according to the invention will now be considered.

### Cytotoxicity Test

A cytotoxicity test was carried out on two adhesive compositions according to the invention and four commercially available adhesive compositions for pouches for receiving body fluids (“Alterna +”, “Moderma Flex”, “Nuance light nova” and “Esteem”).

The test was carried out simultaneously for all the compositions, under the same conditions and on a single preparation containing human skin cells of the same strain. In view of the scattering of the results of this test, the aberrant values and the extreme values should be eliminated. The results are set out in the form of a rate of destruction of the cells. The higher the (negative) value, the more aggressive the composition is toward the skin.

The two compositions according to the invention were given values of −12% and −14.5% respectively. The four compositions of known products were given results of −17%, −27%, −18% and −34%.

Given that a variability rate of 5% in the cytotoxicity test is considered to be significant, it is clear that the adhesive compositions according to the invention are less aggressive than the four commercially available compositions.

### Patient Tolerance Tests

Tests were carried out under hospital and environment conditions, i.e. under conditions in which the pouch was fitted and removed by hospital staff. The hospital staff determined the convenience of fitting and removal and the presence of any leakage. The patients themselves evaluated the resulting comfort, in terms of whether or not they were aware of the presence of the pouch and any irritation problems.

The results reveal that the elements made from the compositions according to the invention greatly simplify fitting and removal, owing to the very high flexibility of the composition. Almost at no stage were patients aware of the presence of the pouch for receiving body fluids.

These results are attributed not only to the quality of the adhesiveness obtained but also to the very high flexibility and the absence of irritation. In particular, the weld produced between an adhesive element provided with a polyethylene film and the pouch around the hole formed in the adhesive element does not reduce the very high flexibility and improves patient comfort.

Thus, the invention relates to adhesive compositions and attachment elements having excellent adaptability owing to their very high flexibility, which is a considerable advantage both during fitting and removal of the composition and in terms of the wearer's awareness of its presence.

1. Adhesive composition intended for attachment to human skin, characterised in that it contains from 55 to 75% of a continuous phase and from 25 to 45% of a discontinuous phase consisting of hydrophilic polymers in the form of hydrocolloids, the continuous phase containing from 5 to 10% of a texture copolymer consisting of a styrene-isoprene-styrene or styrene-butadiene-styrene-type block copolymer having a majority of at least triple blocks, more than 22% of tackifying agent and from 10 to 30% of a plasticiser, these percentages being given relative to the composition as a whole.

2. Composition according to claim 1, characterised in that the continuous phase contains at most 40% of tackifying agent and at most 28% of a plasticiser, these percentages being given relative to the composition as a whole.

3. Composition according to claim 2, characterised in that the continuous phase contains from 6 to 10% of a texture copolymer, from 23 to 38% of tackifying agent and from 13 to 25% of a plasticiser, these percentages being given relative to the composition as a whole.

4. Composition according to claim 1, characterised in that the tackifying agent is a mixture of tackifying agents containing a majority of high-activity tackifying agents based on terpene resins and a significant amount of a tackifying agent with low activity of adhesiveness but also having a reinforcing effect.

5. Composition according to claim 4, characterised in that at least half of the tackifying agent consists of a high-activity tackifying agent based on polyterpene resin.

6. Composition according to claim 3, characterised in that at most one third of the tackifying agent is a low-activity tackifying agent forming a reinforcing resin.

7. Composition according to claim 1, characterised in that the texture copolymer of the continuous phase is a styrene-isoprene-styrene block copolymer composed at least for the most part of at least triple sequences, the double sequences forming at most a minority of the copolymer.

8. Composition according to claim 1, characterised in that the discontinuous phase consisting of hydrophilic polymers in the form of hydrocolloids contains a significant amount of at least one compound selected from cellulose fibres, caroxymethylcellulose, hydroxyethylcellulose, compounds similar to guar gum, and alginates.

9. Composition according to claim 1, characterised in that it also comprises an agent having a medical effect.

10. Element for attaching a pouch for collecting body fluids, characterised in that it comprises the adhesive compound according to claim 1 and, on the face remote from that which is intended to be in contact with the skin, a film having a property for transferring water in one direction.

11. Element according to claim 10, characterised in that the film is a polyethylene film having standardised microperforations allowing water to pass in one direction but not in the other.

12. Composition according to claim 2, characterised in that the tackifying agent is a mixture of tackifying agents containing a majority of high-activity tackifying agents based on terpene resins and a significant amount of a tackifying agent with low activity of adhesiveness but also having a reinforcing effect.

13. Composition according to claim 3, characterised in that the tackifying agent is a mixture of tackifying agents containing a majority of high-activity tackifying agents based on terpene resins and a significant amount of a tackifying agent with low activity of adhesiveness but also having a reinforcing effect.

14. Composition according to claim 4, characterised in that at most one third of the tackifying agent is a low-activity tackifying agent forming a reinforcing resin.

15. Composition according to claim 2, characterised in that the texture copolymer of the continuous phase is a styrene-isoprene-styrene block copolymer composed at least for the most part of at least triple sequences, the double sequences forming at most a minority of the copolymer.

16. Composition according to claim 2, characterised in that the discontinuous phase consisting of hydrophilic polymers in the form of hydrocolloids contains a significant amount of at least one compound selected from cellulose fibres, caroxymethylcellulose, hydroxyethylcellulose, compounds similar to guar gum, and alginates.

17. Composition according to claim 2, characterised in that it also comprises an agent having a medical effect.
